(19) United States
(12) Patent Application Publication
(10) Pub. No.: US 2004/0101165 A1
(43) Pub. Date: May 27, 2004

(54) Multi-functional optical detection system for a vehicle

(76) Inventors: Yann Le Gallo, Orleans (FR); Dominique Benoit, St. Jean Le Blanc (FR)

Correspondence Address: CARLSON, GASKEY & OLDS, P.C., 400 WEST MAPLE ROAD, SUITE 350, BIRMINGHAM, MI, 48009, US

(21) Appl. No.: 10/672,285

(22) Filed: Sep. 26, 2003

(30) Foreign Application Priority Data
Sep. 26, 2002 (FR) 02 11 924

(51) Int. Cl. G06K 9/00

(52) U.S. Cl. 382/104

(57) ABSTRACT

An object detection system for a motor vehicle comprises at least one optical sensor, a lens that directs an image of the handle and/or of a window trap area the optical sensor, and a display displaying the image of the area behind the vehicle. The object detection system can be operably coupled to a window lifter motor for driving the window and/or a handle for operating an opening leaf, such as a vehicle door

### REFERENCE TO RELATED APPLICATIONS

This patent application claims priority to French patent application FR 02 11 924 filed on Sep. 26, 2002.

### TECHNICAL FIELD

The invention relates to objection-detection systems for motor vehicles and more particularly to optical objection detection systems.

### BACKGROUND OF THE INVENTION

Electric motors are increasingly popular in driving window lifters. It is possible in these systems for an object or someone's hand to accidentally lie in the ascending path of the window and become trapped between the top of the window and the door upright, creating a situation for potential damage or injury. To prevent this, various devices have been developed to halt the movement of the window or forcing the window to move back down are known. Object detection devices are also desirable in, for example, keyless locks to detect the presence of a magnetic key.

For example, U.S. Pat. No. 5,506,567 discloses a window lifter equipped with an anti-trap device. This anti-trap device has an infrared optical sensor and a lens that directs an image of a trap area towards the infrared optical sensor.

Another proposed system has a rear camera and a screen in the cabin for rear view. French patent 2,672,857 discloses a vehicle rear-view device. This device consists of a camera arranged on the side of the vehicle and a display arranged in the cabin of a vehicle and connected to the camera to portray the images seen by the camera.

Yet another proposed object detection system is used as a detection device for a keyless lock. This device comprises emitting/receiving diodes operating in the infrared and arranged in a handle of an opening door.

A vehicle equipped with the devices currently known in the art is complicated, expensive, bulky and heavy. Further, existing object detection equipment is not very affordable and is reserved for top-of-the-range vehicles.

There is a desire for an object detection system that is simpler and less expensive than currently known systems, allowing it to be more widely used in vehicles over different price ranges.

### SUMMARY OF THE INVENTION

One embodiment of the invention is directed to an object detection system for a motor vehicle comprising at least one optical sensor, a window lifter equipped with a window and with a motor for driving the window and/or a handle for operating a vehicle leaf, such as a vehicle door, a lens that directs an image of an area behind the vehicle and at least one an image of the handle and the image of a window trap area toward the optical sensor, and a display connected to the optical sensor and that displays the image of the area behind the vehicle.

According to one embodiment, the lens directs the different images toward the same optical sensor. Advantageously, the sensor is a charged coupled device sensor. According to another embodiment, the vehicle has several optical sensors, and the lens directs at least two of the images towards different optical sensors.

According to yet another embodiment, the vehicle comprises a window lifter and an image processing device connected to the optical sensor to which the image of the trap area is directed. The image processing device supplies a signal representing the presence of a foreign object in the window lifter trap area.

Advantageously, the vehicle further comprises a switch that cuts off the power supply to the motor when the processing device determines the presence of a foreign object.

According to one embodiment, the vehicle comprises a leaf opening handle and an image processing device connected to the optical sensor, which receives the image of the handle. The image processing device supplies a signal representing the presence of an object near the handle.

According to another embodiment, the optical sensor to which the image behind the vehicle is directed is sensitive to visible light.

According to yet another embodiment, the images directed by the lens are contained in distinct solid angles.

In one embodiment, the opening leaf is a door and the lens is placed at a waistline area of the door.

The invention also relates to a detection method comprising the steps of supplying a vehicle equipped with at least one optical sensor and with a lens able to focus images towards the optical sensor, using the lens to direct an image behind the vehicle towards the sensor, and using the lens to direct at least one image of a handle for operating an operating leaf of the vehicle or of a vehicle window trap area towards a sensor.

According to one embodiment, the images are directed towards different respective areas of the same optical sensor.

According to another embodiment, at least two of the images are directed toward different sensors.

According to yet another embodiment, the method further comprises a step of displaying the image of an area behind the vehicle directed towards the sensor.

Advantageously, the method comprises directing the image of the trap area towards the sensor and supplying a signal representative of the presence of a foreign object in the trap area.

According to another embodiment, the method further comprises disconnecting the power supply to a motor that drives the window when the signal indicates the presence of a foreign object in the trap area.

Advantageously, the method comprises directing the image of the handle towards the sensor, processing the image of the handle, and supplying a signal representing the presence of an object near the handle.

According to one embodiment, the images directed are contained in distinct solid angles.

Other characteristics and advantages of the invention will become apparent from reading the description which follows of some embodiments of the invention, given by way of example and made with reference to the attached drawings.

### BRIEF DESCRIPTION OF THE DRAWINGS

FIG. 1 is a representative perspective view of a door equipped with a lens for directing images whose cones of vision have been depicted;

FIG. 2 is a representative diagram depicting the lens and an associated optical sensor;

FIG. 3 is a representative diagram of an image processed for a window lifter anti-trap application.

### DETAILED DESCRIPTION OF THE PREFERRED EMBODIMENT

Generally, the invention proposes using a single lens to direct a rear-view image and at least one other image onto one or more optical sensors.

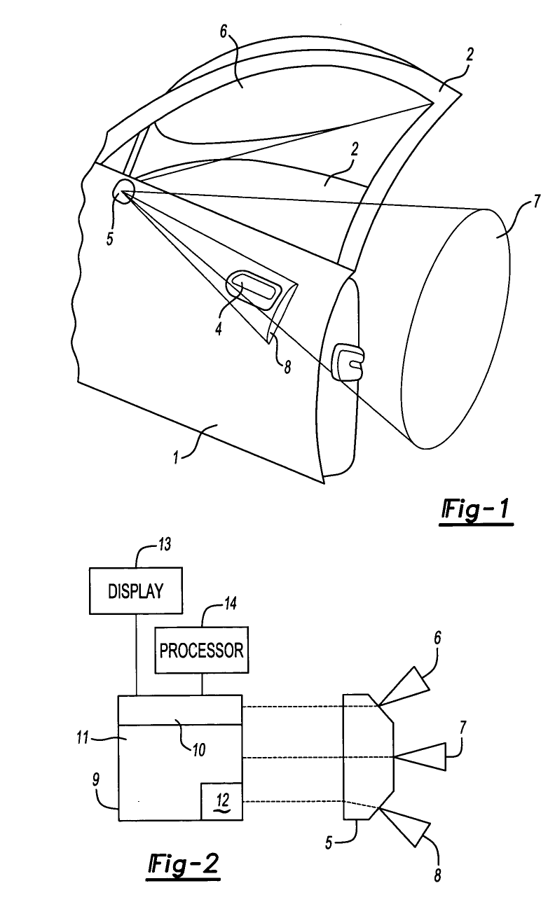

FIG. 1 schematically depicts a door 1 equipped with a window 2, a window surround 3, an actuating handle 4 designed for opening the door, and a lens 5. The lens in this example has three optical parts. Each optical part is devoted to directing an image of one area in the space occupied by the vehicle or the vehicle surroundings. The lens 5 thus directs the images of three areas in space, which are represented by three truncated cones 6, 7 and 8 in the Figures. The lens may thus direct the image from at least one solid angular portion. The images of these areas are directed towards one or more optical sensors 9.

According to one embodiment, the lens 5 directs an image of an area behind the vehicle (represented by truncated cone 7 in this example) and at least one other image toward an optical sensor 9. The lens 5 can therefore also direct the image of the door-opening handle 4 (represented by the truncated cone 8 in this example) and/or the image of a trap area (represented by the truncated cone 6 in this example) toward the optical sensor 9. Of course, the lens may also be to direct all three images described above toward the optical sensor.

In this example, the truncated cone 7 corresponds to the image of a monitored window trap area and the truncated cone 6 corresponds to the image of the area swept by the top of the window 2 at the end of its travel. The image corresponding to truncated cone 6 is used to detect the trapping of an object in the case of a window driven by a motorized window lifter. In this example, it is possible to determine that an object is trapped between the window 2 and the surround 3.

The truncated cone 8 corresponds to the image of the door handle and of the surrounding area. In particular, the lens 5 may direct an image of an area covering any object situated less than 100 mm away from the handle to the optical sensor 9. Subsequent processing of this image makes it possible to detect the presence of an object near the handle 4. In one embodiment, detection of the presence of an object near the handle makes it possible to initiate an unlocking function on a latch (not shown) operable by the handle before an attempt is made at opening the door. Proximity detection may, in particular, start routines for detecting magnetic keys or for preparing to open the door to reduce the response time between a door opening request and the actual door opening.

The lens 5 is preferably arranged at a “waistline” of the door as depicted in FIG. 1. As can be seen in FIG. 1, the door waistline is at an area where the vehicle window meets the body of the door. At this location, the lens 5 can easily cover the various areas described above. The lens 5 is also preferably disposed at the front of the window opening. This placement is thus suitable for directing the image of the trap area, the rear-view image and the image of the handle using just one side of the lens.

Any appropriate lens structure may be used for directing the images toward the optical sensor 9. In one example, lenses such as the “01LCP plano-cylindrical glass lens” by Melles Griot may be used in the inventive system.

The optical sensor 9 is preferably fixed to the vehicle door. It is thus possible to reduce the distance of the optical path between the lens 5 and the sensor 9. The sensor 9 is preferably arranged inside the door in order to protect it.

FIG. 2 schematically depicts a lens 5 and an optical sensor 9 associated with this lens. The images directed by the lens 5 are directed toward the sensor 9 along light paths depicted schematically by the discontinuous lines. The directing of images toward a sensor along light paths is generally known. In this example, the different images corresponding to the various cones 6, 7 and 8 are directed onto the same sensor 9. It is thus possible for several optical detection functions to be performed using a single sensor 9. The pixels of the sensor 9 thus have information which is dependent on the location and brightness of an object placed in the field of an image directed toward the sensor. The images corresponding to the truncated cones 6, 7, 8 are directed toward respective corresponding areas 10, 11, 12 of the sensor 9. Each image type 6, 7, 8 is preferably projected onto a distinct area 10, 11, 12 of the sensor 9. A single sensor 9 is used in this example instead of multiple sensors, thereby avoiding increased complexity in connecting and managing system components. It is also possible to envision some degree of overlap of the image capture areas, such as, for example, between the rear-view capture area 7 and the handle proximity detection area 8.

In one embodiment, the sensor 9 is a charge coupled device (CCD), which allows several functions to be performed conveniently by a single sensor. This is because charge coupled devices are sensitive both to the visible spectrum and to the infrared spectrum and are particularly sensitive in the infrared spectrum. In one embodiment, the rear-view function calls upon the visible spectrum, while the trap detection or handle proximity detection functions call upon both the visible and infrared spectra in order to exhibit good performance. This is because by night, the trap detection and proximity detection functions work better in the infrared range of the spectrum.

It is also possible to envision two distinct images to be directed by the lens 5 towards different respective sensors rather than the same sensor. In this embodiment, each individual sensor may be made sensitive to spectra corresponding to the functions performed by that sensor. For example, the rear-view images may be directed toward a sensor more sensitive to the visible light spectrum and the images of the handle and/or of the trap area may be directed toward a sensor more sensitive to the infrared light spectrum.

The sensor 9 is connected to a display 13 and/or an image processing module 14. The images to be processed by the processing module 14 may be processed by one or more appropriate processors placed in the module 14.

The processing of a rear-view image, corresponding to area 11 of the sensor 9 in this example, may in particular eliminate any distortion there might be in the rear-view image provided by the lens 5. It is also possible to modify the brightness of the displayed image according to the ambient brightness.

The display 13 may be disposed inside the cabin of the vehicle and may display the images from one or more of the sensors 9. It is also possible to display the rear-view images provided by various multiple sensors on the same display. For example, it is possible to combine the images provided by two lateral rear-view sensors and a central rear-view sensor on a single display arranged inside the cabin of the vehicle.

The processing of an image of the handle may comprises determining the presence of an object in this area and determining the distance between the object and the handle, making it possible to anticipate the opening of the door and unlock the door accordingly.

The processing of the image of the trap area generally comprises determining the presence of an object in this area, determining whether this object is likely to become trapped, or determining the distance between this object and the lens. The processing may exclude the window from the objects to be detected to prevent a detection error the window is rolled back up. In one embodiment, the image processing may comprise measuring the variations in color or brightness of the image of the trap area over time.

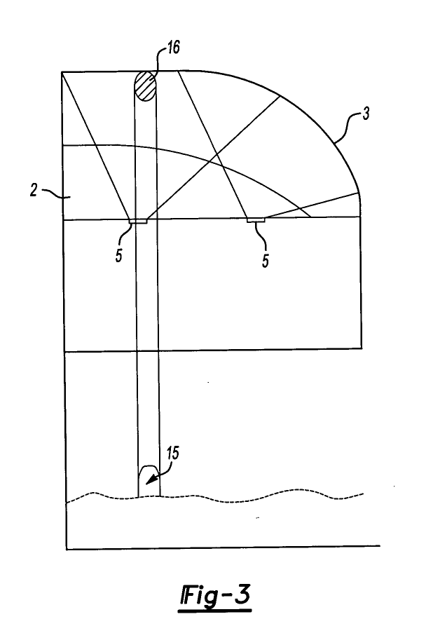

FIG. 3 depicts an example of a possible trapping detection process. This example incorporates generally viewing the image of a trapping curve, defined in this example by the upper slot of the window surround designed to accommodate the closed window. The upper part of FIG. 3 represents the trap area itself and any objects placed in the trap area. The lower part of the figure represents, for example, the brightness or other characteristic seen by the sensor 9. In one embodiment, the brightness of the image seen by the sensor 9 is, on the whole, inversely proportional to the square of the distance separating the lens 5 from the object. Thus, the processing module 14 can detect a brightness above a given threshold in the trap area. FIG. 3 depicts a brightness spike 15 corresponding to the presence of the object 16 in the trap area, which is detected by the processing module 14. This determination may used to stop the motor in the window lifter or force the window back down. In the illustrated example, two lenses 5 are used to direct the image of the entire trap area. The images from the lenses 5 can be directed to respective sensors corresponding to the lenses 5. Image processing can be carried out to reconstruct a single image from the images obtained by the combination of lenses and sensors.

Of course, the present invention is not limited to the examples and embodiments described and depicted but can be varied in numerous ways accessible to those skilled in the art. Thus, although the invention has been described hitherto with reference to a door, it would also be possible to envisage adapting the invention to some other opening leaf such as the trunk or a sunroof. It is thus possible to envisage using one and the same lens to provide rear view and to detect an approach towards the handle of the trunk. It is also possible to envisage the use of this same lens to collect obstacle distance detection signals when the vehicle is reversing.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An object sensing system for a motor vehicle, comprising:
at least one optical sensor;
a lens that directs a first image of a first vehicle area and a second image of a second vehicle area toward said at least one optical sensor;
a display connected to said at least one optical sensor to display at least one of the first and second images.

2. The system of claim 1, wherein the lens directs the first and second images toward one optical sensor.

3. The system of claim 2, wherein the first and second images are directed to first and second areas, respectively, of the optical sensor.

4. The system of claim 1, wherein said at least one optical sensor comprises at least a first optical sensor and a second optical sensor, and wherein the lens directs the first image to the first optical sensor and the second image to the second optical sensor.

5. The system of claim 4, wherein the first optical sensor is sensitive to visible light and the second optical sensor is sensitive to infrared light.

6. The system of claim 1, wherein said at least one optical sensor is a charge coupled device sensor that is sensitive to both visible light and infrared light.

7. The system of claim 1, wherein the first image corresponds to an area behind the vehicle and the second image corresponds to at least one of a vehicle handle area and a window trap area.

8. The system of claim 1, wherein the first and second images directed by the lens are contained in distinct solid angles.

9. The system of claim 1, further comprising an image processing device, connected to said at least one sensor, wherein the image processing device generates a signal that indicate a presence of a foreign object in at least one of the first and second images.

10. The system of claim 9, wherein the image processing device detects the foreign object by detecting if a brightness of a portion at least one of the first and second images crosses a threshold.

11. An object sensing system for a motor vehicle having a window lifter and a handle for operating a vehicle leaf, the system comprising:
at least one optical sensor;
a lens that directs a first image of a first vehicle area a second image of a second vehicle area toward said at least one optical sensor, wherein the first vehicle area is a rear view area behind the vehicle and the second vehicle area is one selected from the group consisting of the handle and a window lifter trap area;
a display connected to said at least one optical sensor to display at least one of the first and second images.

12. The system of claim 11, wherein the lens directs the first and second images toward one optical sensor.

13. The system of claim 12, wherein the first and second images are directed to first and second areas, respectively, of the optical sensor.

14. The system of claim 11, wherein said at least one optical sensor comprises at least a first optical sensor and a second optical sensor, and wherein the lens directs the first image to the first optical sensor and the second image to the second optical sensor.

15. The system of claim 14, wherein the first optical sensor is sensitive to visible light and the second optical sensor is sensitive to infrared light.

16. The system of claim 11, wherein said at least one optical sensor is a charge coupled device sensor that is sensitive to both visible light and infrared light.

17. The system of claim 11, further comprising an image processing device, connected to said at least one sensor, wherein the image processing device generates a signal that indicate a presence of a foreign object in at least one of the first and second images.

18. The system of claim 17, wherein the second vehicle area is the window trap area, and wherein the system further comprises a switch that cuts of a power supply to a motor in the window lifter when the foreign object is detected in the second image.

19. The system of claim 17, wherein the second vehicle area is the handle, further comprises a switch that places the handle in an unlocked position when the foreign object is detected in the second image.

20. The system of claim 11, wherein the vehicle leaf is a door, and wherein the lens is disposed at a waistline of the door.

21. An object detection method for a motor vehicle having a window lifter and a handle for operating a vehicle leaf, comprising:
capturing a first image of a first vehicle area and a second image of a second vehicle area, wherein the first vehicle area is a rear view area behind the vehicle and the second vehicle area is one selected from the group consisting of the handle and a window lifter trap area;
directing the first and second images to at least one optical sensor;
detecting a foreign object in the second image; and
controlling operation of at least one of the window lifter and the handle if the foreign object is detected.

22. The method of claim 21, further comprising displaying at least one of the first and second images on a display.

23. The method of claim 21, wherein the first and second images are directed towards different respective areas of a single optical sensor.

24. The method of claim 21, wherein the first and second images are directed toward different optical sensors.

25. The method of claim 21, further comprising cutting off of a power supply driving the window lifter if the foreign object is detected in the window lifter trap area.

26. The method of claim 21, further comprising placing the handle in an unlocked position if the foreign object is detected in the second image.
